(19) United States
(12) Patent Application Publication
(10) Pub. No.: US 2026/0042712 A1
(43) Pub. Date: Feb. 12, 2026

(54) DEVICES HAVING THREE-DIMENSIONAL SHAPES ATTACHED TO THIN CERAMIC SUBSTRATES AND METHODS OF MAKING

(71) Applicant: CORNING INCORPORATED, CORNING, NY (US)

(72) Inventors: Stephen Thomas Barrett, Corning, NY (US); Andrey Kobyakov, Painted Post, NY (US); Daniel Wayne Levesque, JR., Bath, NY (US); Tianqi Ren, Painted Post, NY (US); Heather Nicole Vanselous, Corning, NY (US)

(21) Appl. No.: 19/286,764

(22) Filed: Jul. 31, 2025

Related U.S. Application Data
(60) Provisional application No. 63/680,788, filed on Aug. 8, 2024.

(51) Int. Cl. C04B 37/00; C04B 35/48; C04B 35/638; C04B 35/64

(52) U.S. Cl. CPC C04B 37/001; C04B 35/48; C04B 35/638; C04B 35/64; C04B 2235/3225; C04B 2235/3246; C04B 2235/612; C04B 2235/6567; C04B 2237/348; C04B 2237/84

(57) ABSTRACT

Devices and methods having embedded three-dimensional structures in thin ceramic substrates, including but not limited to dielectric resonator antennas (DRAs), and devices used in electronics, radio frequency (RF) antennas, sensors, and other applications. A hole is formed in the surface of an unsintered ceramic substrate, and a three-dimensional object is inserted through the hole and into the substrate. The substrate and inserted object are then heated to high temperatures to sinter the substrate and to covalently bond the object to the substrate, thereby securely attaching the object to the substrate surface generally without a need to use adhesives.

### CROSS-REFERENCE TO RELATED APPLICATION

This application claims the benefit of priority under 35 U.S.C. § 119 of U.S. Provisional Application Serial No. 63/680788 filed on Aug. 8, 2024, the content of which is relied upon and incorporated herein by reference in its entirety.

### BACKGROUND

This disclosure relates to devices and methods having embedded three-dimensional structures in thin ceramic substrates, including but not limited to devices used in electronics, dielectric resonator antennas, radio frequency (RF) antennas, sensors, and other applications.

Previous conventional methods for manufacturing devices, such as printed circuit boards, that have antennas, pins, or other objects attached to a ceramic substrate generally drill holes into the substrate surface and then fix the objects into place using only glue or other types of adhesives.

Over the past few years, thin ribbon ceramics have demonstrated considerable potential for RF applications at 30-60 GHz (mm-waves). In particular, dielectric resonator antennas (DRAs) can benefit from the electromagnetic and mechanical properties of ribbon ceramics. Apart from low loss tangent, which is especially critical for mm-wave applications, mechanical flexibility of the thin ceramic substrate provides another degree of freedom to control the radiation pattern and resonance frequency of a DRA. A challenge that hinders wider adoption of this technology is the difficulty of securely attaching antennas, pins, and other objects to the surface of a thin substrate. The use of glue and epoxies alone are often unsuitable for attaching three-dimensional objects to such thin substrates because of the very small contact area and mechanical stresses that arise in these devices.

Accordingly, there is a need for improved thin ceramic substrates with attached three-dimensional objects and methods of making.

### SUMMARY

The present disclosure relates to methods for attaching three-dimensional structures to thin ceramic substrates and resulting devices thereof. For example, one aspect of the disclosure provides a device by forming a hole in the surface of an unsintered ceramic precursor, inserting a three-dimensional structure into the hole, and then sintering the ceramic precursor and inserted structure to covalently bond or lock the structure in place.

In an aspect, the present disclosure provides a device comprising a ceramic substrate having a hole in a surface of the substrate, and a non-planar object inserted into the hole in the surface and in contact with the substrate. In an aspect, the ceramic substrate is a thin ceramic substrate, such as a ribbon ceramic, having a thickness of 200 μm or less. The substrate comprises any ceramic material that is suitable for use in electronic, RF antenna, and dielectric resonator antenna (DRA) devices, and that forms a stable substrate after being exposed to a high temperature, such as a sintering temperature, and the object inserted into the surface of the substrate comprises a glass, ceramic, glass-ceramic material, and/or a precursor of any of these materials (i.e., a precursor of a glass material, a precursor of a ceramic material, or a precursor of a glass-ceramic material). In some aspects, the substrate comprises a sintered ceramic that is covalently bonded with the object inserted into the hole in the surface of the substrate.

In an aspect, the present disclosure provides a method of making a sintered ceramic device comprising the steps of: a) generating a hole in a surface of a substrate, wherein the substrate comprises an unsintered ceramic having one or more organic dispersants and/or binding agents; b) inserting a non-planar object into the hole in the substrate surface and in contact with the substrate, where the object comprises a glass, ceramic, or glass-ceramic material, or precursor thereof, and is stable at temperatures between 850° C. and 3,000° C.; and c) heating the substrate containing the inserted non-planar object to a temperature between 850° C. and 3,000° C. for a time period from 1 to 60 minutes resulting in covalent bonding of the non-planar object to the substrate.

In an aspect, the method further comprises generating the hole in the substrate surface by mechanical drilling the substrate surface, puncturing the substrate surface, etching or ablating the hole in the substrate surface using a laser, or any combination thereof. A further aspect comprises drilling or etching one or more slits or cutouts radially extending from a center of the hole along the substrate.

In an aspect, the device is a dielectric resonator antenna (DRA) comprising a ceramic substrate having a first substrate surface and an opposing second substrate surface, wherein the substrate comprises a hole in the first substrate surface, the first substrate surface is metallized, and the substrate has a thickness of 200 μm or less. The DRA further comprises a resonator inserted into the hole in the first substrate surface and in contact with the substrate, wherein the resonator comprises a glass, ceramic, glass-ceramic material, or a precursor thereof. The DRA also comprises a probe antenna inserted in the substrate and having a first end extending above the first substrate surface and a second end extending into the substrate, wherein a portion of the probe antenna is in contact with the metallized surface. In an aspect, the DRA is made from a green material (green tape) comprising one or more organic dispersants and/or binding agents, where the substrate is able to undergo lateral shrinkage when heated to a temperature capable of sintering the substrate.

Additional features and advantages will be set forth in the detailed description which follows, and in part will be readily apparent to those skilled in the art from that description or recognized by practicing the aspects as described herein, including the detailed description, the claims, as well as the appended drawings.

The accompanying drawings are included to provide a further understanding of principles of the disclosure, and are incorporated in, and constitute a part of, this specification. The drawings illustrate one or more aspect(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the aspects as described herein.

### BRIEF DESCRIPTION OF THE DRAWINGS

FIG. 1 shows schematics of dielectric resonator antennas excited by a monopole (probe) antenna: (panel a) a single resonator glued to a substrate; (panel b) a single resonator inserted in a pre-fabricated hole in accordance with the disclosure; (panels c and d) different views of a compound, three-resonator DRA, in accordance with the disclosure. Each individual resonator in panels b, c, and d is attached via insertion in a pre-fabricated hole.

FIG. 2 shows fabrication steps of a dielectric resonator antenna (DRA).

FIG. 3 shows a microscope image of ceramic pin embedded in a 3 mol % yttria-stabilized zirconia (“3YSZ”) substrate before sintering. Left panel: Ceramic pin placed in hole, small crack observed. Hole with large cracks was a location where the pin was inserted and removed again. Right panel: Zoomed in images of cracks in green tape around the embedded pin.

FIG. 4 shows a box plot of shrinkage seen in zirconia green tape upon firing for both micron level and millimeter scale features.

FIG. 5 shows microscope image of a ceramic pin embedded in 3YSZ after sintering. Panel A) Top side of pin, Panel B) bottom side of pin, Panel C) magnified image of top side of pin, Panel D) magnified image of bottom side of pin.

FIG. 6 (left panel) shows a top-view schematic of a patterned opening on green tape. The ceramic pin can be pushed through the middle of the open so that its outer surface is surrounded by the “wings” of the green tape. Right panel shows an image of green tape after pin was inserted and removed.

FIG. 7 shows an alternative hole shape concept with round cut-outs to relieve stress during object insertion and sintering. Panel a) shows ablated hole after a ceramic pin was inserted and removed. Panels b-d) show different views of the inserted pin. No cracks were observed in the green tape.

### DETAILED DESCRIPTION

Over the past few years, ribbon ceramics have demonstrated considerable potential for radio frequency (RF) applications at 30-60 GHz (mm-waves). Relatively thin (˜100 μm) high-permittivity (˜10) alumina sheets were shown to work as substrates for planar antennas and transmission lines (Aslani-Amoli et al. “Transmission lines on alumina ribbon ceramic substrate material for 30 to 170 GHz wireless applications,” in Proc. 2021 IEEE 71st Electronic Components and Technology Conference (ECTC), San Diego, CA, USA, Jun.1-4, 2021). The main challenge, however, that hinders the wider adoption of this technology is the complexity of mechanical processing. Specifically, producing metallized vias in ceramic substrates and fabrication of multi-layer structures for broadband antennas turned out to be particularly difficult and expensive.

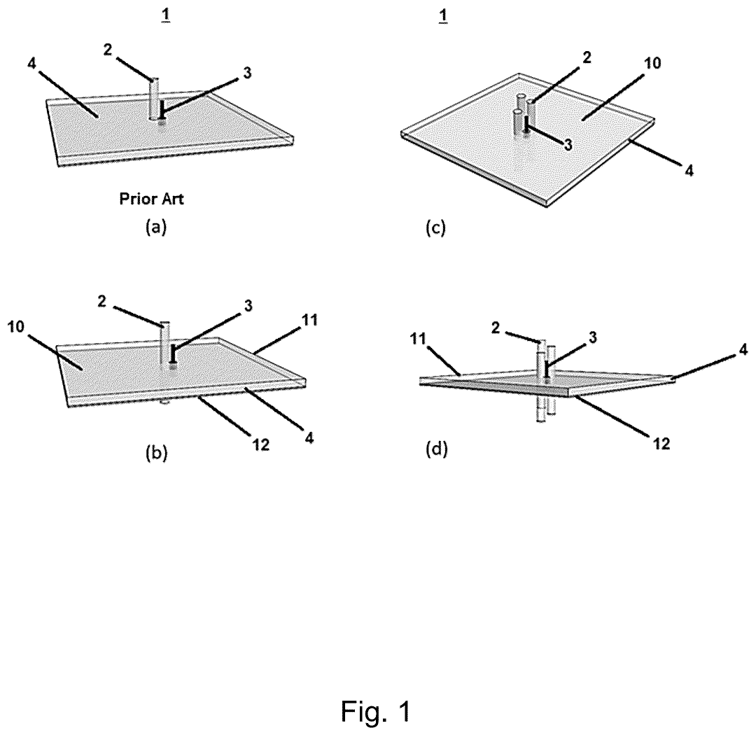

Another type of antenna, which recently gained a lot of research interest, is dielectric resonator antennas (DRAs). A typical DRA consists of a feeding structure, such as a monopole antenna over a ground plane, coupled to a dielectric resonator (see FIG. 1, panel a). The shape, size and permittivity of the resonator largely determines the radiation properties of the DRA.

DRAs, which do not require multi-layer substrates, can benefit from the electromagnetic and mechanical properties of ribbon ceramics. Apart from low loss tangent, which is especially critical for mm-wave applications, mechanical flexibility of the substrate provides another degree of freedom to control the radiation pattern and resonance frequency of a DRA. Methods to form complex resonator shapes from individual building blocks (i.e., a compound DRA) are also available.

However, the main challenge for DRAs is the mechanical attachment of a single-piece or a compound resonator to the substrate. In general, it is difficult to attach three-dimensional objects to thin ceramic substrates using conventional methods. Previous solutions related to printed circuit boards mechanically drill holes into the substrate surface, and the object (i.e., a pin) is fixed in place using only glue or another type of adhesive. However, glues and other adhesives alone are a poor choice for high aspect ratio resonators or individual building blocks because of the very small contact area and mechanical stresses in the conformal (bent substrate) geometry that these devices can take.

The present disclosure provides alternative devices and methods where individual resonators (or other three-dimensional objects) are reliably embedded in a ceramic substrate. The three-dimensional structures are embedded in ribbon ceramics or other thin ceramic substrates using a process of, for example, laser drilling holes in an unsintered ceramic substrate (i.e., green tape), inserting the resonator, and then sintering the substrate to lock the resonator in place. The proposed methods can be generalized to other applications that require a planar ceramic sheet holding three-dimensional objects, particularly ceramic objects of the same or different permittivity. In some aspects, a glue or adhesive is not employed to attach the three-dimensional structures to the ceramic substrate (e.g., ribbon or thin ceramics). In some aspects, at least some glue or adhesive is employed in combination with sintering so as to attach the three-dimensional structures to the ceramic substrate (in such a case, generally the sintering occurs first followed by use of glue or adhesive, but in some aspects the glue or adhesive can be employed before sintering).

In an aspect, the present disclosure provides a device comprising a ceramic substrate having a hole in a surface of the substrate, and a non-planar object inserted into the hole in the surface, where the object is in contact with the substrate. The substrate has a thickness (μm) of at least 5, at least 10, at least 20, at least 30, at least 40, at least 50, at least 75, at least 100, at least 125, at least 150, at least 175, at least 200, at least 225, at least 250, at least 275, 300 or less, 275 or less, 250 or less, 225 or less, 200 or less, 175 or less, 150 or less, 125 or less, 100 or less, 75 or less, 50 or less, 40 or less, 30 or less, 20 or less, 10 or less, or any range formed therefrom. For example, in some aspects, the thickness is between 5 μm and 300 μm, such as a thickness of 200 μm or less, 150 μm or less, 100 μm or less, 40 μm or less, or between 10 μm and 20 μm. In an aspect, the substrate is a ribbon ceramic.

In an aspect, the substrate comprises any ceramic material that is suitable for use in electronic, RF antenna, and dielectric resonator antenna (DRA) devices, and that forms a stable substrate after being exposed to a temperature of at least 700° C., at least 800° C., at least 900° C., at least 1,000° C., at least 1,100° C., at least 1,200° C., at least 1,300° C., at least 1,400° C., at least 1,500° C., at least 1,600° C., at least 1,700° C., at least 1,800° C., at least 1,900° C., at least 2,000° C., at least 2,100° C., at least 2,200° C., at least 2,300° C., at least 2,400° C., at least 2,500° C., at least 2,600° C., at least 2,700° C., at least 2,800° C., at least 2,900° C., 3,000° C. or less, 2,900° C. or less, 2,800° C. or less, 2,700° C. or less, 2,600° C. or less, 2,500° C. or less, 2,400° C. or less, 2,300° C. or less, 2,200° C. or less, 2,100° C. or less, 2,000° C. or less, 1,900° C. or less, 1,800° C. or less, 1,700° C. or less, 1,600° C. or less, 1,500° C. or less, 1,400° C. or less, 1,300° C. or less, 1,200° C. or less, 1,100° C. or less, 1,000° C. or less, 900° C. or less, 800° C. or less, or any range formed therefrom. For example, in some aspects, the substrate comprises any ceramic material that forms a stable substrate after being exposed to temperatures between 850° C. and 3,000° C., such as between 900° C. and 2,500° C., between 1,000° C. and 1,900° C., between 1,000° C. and 2,000° C., or between 1,500° C. and 1,900° C.. In an aspect, the ceramic substrate comprises aluminum oxide (Al₂O₃), aluminium oxynitride ((AlN)ₓ—(Al₂O₃)₁₋ₓ), silicon carbide (SiC), silicon nitride (Si₃N₄), titanium carbide (TiC), titanium nitride (TiN), titanium oxide (TiO₂), yttrium oxide (Y₂O₃), stabilized zirconium dioxide (ZrO₂), zirconium carbide (ZrC), magnesium oxide (MgO), or any combination thereof.

Optionally, the substrate comprises an unsintered ceramic precursor comprising one or more organic dispersants and/or binding agents. For example, as is known in the art, green tape is a ceramic or dielectric tape that has not been fired or sintered, or at least not completely fired or sintered, and as such may still contain organic dispersants and/or binding agents. The dispersants and/or binding agents in the ceramic precursor are removed or substantially removed from the substrate when the ceramic precursor is exposed to a sintering temperature. In an aspect, a substrate comprising an unsintered ceramic precursor undergoes lateral shrinkage of at least 10%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, 30% or less, 29% or less, 28% or less, 27% or less, 26% or less, 25% or less, 24% or less, 23% or less, 22% or less, 21% or less, 20% or less, 19% or less, 18% or less, 17% or less, 16% or less, 15% or less, 14% or less, 13% or less, 12% or less, or any range formed therefrom. For example, in some aspects, the substrate comprising an unsintered ceramic precursor undergoes lateral shrinkage of approximately 15% to 25%, approximately 16% to 20%, or approximately 18% to 22%, when heated to a sintering temperature. In some aspects, the substrate comprises a sintered ceramic that is covalently bonded with the object inserted into the hole in the surface of the substrate.

The object inserted into the surface of the substrate comprises a glass, ceramic, glass-ceramic material, and/or a precursor of any of these materials (i.e., a precursor of a glass material, a precursor of a ceramic material, or a precursor of a glass-ceramic material). For example, the object may comprise a ceramic material that is the same or different than the ceramic material of the substrate. In some aspects, the object is stable at a sintering temperature used to form the substrate. In an aspect, the object is stable at a temperature of at least 700° C., at least 800° C., at least 900° C., at least 1,000° C., at least 1,100° C., at least 1,200° C., at least 1,300° C., at least 1,400° C., at least 1,500° C., at least 1,600° C., at least 1,700° C., at least 1,800° C., at least 1,900° C., at least 2,000° C., at least 2,100° C., at least 2,200° C., at least 2,300° C., at least 2,400° C., at least 2,500° C., at least 2,600° C., at least 2,700° C., at least 2,800° C., at least 2,900° C., 3,000° C. or less, 2,900° C. or less, 2,800° C. or less, 2,700° C. or less, 2,600° C. or less, 2,500° C. or less, 2,400° C. or less, 2,300° C. or less, 2,200° C. or less, 2,100° C. or less, 2,000° C. or less, 1,900° C. or less, 1,800° C. or less, 1,700° C. or less, 1,600° C. or less, 1,500° C. or less, 1,400° C. or less, 1,300° C. or less, 1,200° C. or less, 1,100° C. or less, 1,000° C. or less, 900° C. or less, 800° C. or less, or any range formed therefrom. For example, in some aspects, the object is stable at temperatures between 850° C. and 3,000° C., such as between 900° C. and 2,500° C., between 1,000° C. and 1,900° C., between 1,000° C. and 2,000° C., or between 1,500° C. and 1,900° C.

As used herein, “stable” means that the material making up the substrate and/or object does not decompose at that temperature. A precursor material may undergo a physical transformation, such as the removal of organic dispersants, solvents, and/or binding agents, at the temperature but forms a stable glass, ceramic, or glass-ceramic material as a result of being exposed to the selected temperature or temperatures.

In an aspect, the ceramic material used for the substrate, the object, or both, has a dielectric constant of at least 4, at least 5, at least 6, at least 7, at least 8, at least 9, at least 10, at least 15, at least 20, at least 30, at least 40, at least 50, at least 60, at least 80, at least 100, at least 120, at least 140, at least 160, at least 180, at least 200, at least 220, at least 240, at least 260, at least 280, 300 or less, 300 or less, 280 or less, 260 or less, 240 or less, 220 or less, 200 or less, 180 or less, 160 or less, 140 or less, 120 or less, 100 or less, 80 or less, 60 or less, 50 or less, 40 or less, 30 or less, 20 or less, 15 or less, 10 or less, 9 or less, 8 or less, 7 or less, 6 or less, 5 or less, or any range formed therefrom. For example, in some aspects, the ceramic material used for the substrate, the object, or both, has a dielectric constant between 6 and 250, such as greater than 10. In a further aspect, the ceramic material has a dielectric constant between 8 and 200, or between 10 and 150.

The hole may have any shape that allows the three-dimensional object to be inserted into the substrate, including but not limited to circles, semicircles, ovals, annular rings, polygons, and irregular shapes. In an aspect, the hole is primarily circular and has a diameter or width of at least 0.25 mm, at least 0.3 mm, at least 0.4 mm, at least 0.5 mm, at least 0.8 mm, at least 1 mm, at least 2 mm, at least 3 mm, at least 4 mm, at least 5 mm, at least 6 mm, at least 7 mm, at least 8 mm, at least 9 mm, at least 10 mm, at least 11 mm, at least 12 mm, at least 13 mm, at least 14 mm, at least 15 mm, at least 16 mm, at least 17 mm, at least 18 mm, at least 19 mm, at least 20 mm, at least 21 mm, at least 22 mm, at least 23 mm, at least 24 mm, at least 25 mm, 30 mm or less, 25 mm or less, 24 mm or less, 23 mm or less, 22 mm or less, 21 mm or less, 20 mm or less, 19 mm or less, 18 mm or less, 17 mm or less, 16 mm or less, 15 mm or less, 14 mm or less, 13 mm or less, 12 mm or less, 11 mm or less, 10 mm or less, 9 mm or less, 8 mm or less, 7 mm or less, 6 mm or less, 5 mm or less, 4 mm or less, 3 mm or less, 2 mm or less, 1 mm or less, 0.8 mm or less, 0.5 mm or less, 0.4 mm or less, 0.3 mm or less, or any range formed therefrom. For example, in some aspects, the hole is primarily circular and has a diameter or width between 0.5 mm and 20 mm, such as between 1 mm and 15 mm, between 2 mm and 12 mm, between 5 mm and 10 mm, or between 4 mm and 8 mm. If the hole is not circular, the “diameter” herein refers to the largest dimension. Optionally, the hole may have one or more slits or cutouts radially extending from the center of the hole. If such slits or cutouts are present, the “diameter” herein does not include such slits or cutouts. The hole may extend partially through the substrate, or through the substrate from a first substrate surface to an opposing second substrate surface.

In an aspect, once inserted into the hole in the substrate, the object has a height extending above the substrate surface of at least 0.5 mm, at least 1 mm, at least 2 mm, at least 3 mm, at least 4 mm, at least 5 mm, at least 6 mm, at least 7 mm, at least 8 mm, at least 9 mm, at least 10 mm, at least 11 mm, at least 12 mm, at least 13 mm, at least 14 mm, at least 15 mm, at least 16 mm, at least 17 mm, at least 18 mm, at least 19 mm, at least 20 mm, at least 21 mm, at least 22 mm, at least 23 mm, at least 24 mm, 25 mm or less, 24 mm or less, 23 mm or less, 22 mm or less, 21 mm or less, 20 mm or less, 19 mm or less, 18 mm or less, 17 mm or less, 16 mm or less, 15 mm or less, 14 mm or less, 13 mm or less, 12 mm or less, 11 mm or less, 10 mm or less, 9 mm or less, 8 mm or less, 7 mm or less, 6 mm or less, 5 mm or less, 4 mm or less, 3 mm or less, 2 mm or less, 1 mm or less, or any range formed therefrom. For example, in some aspects, the object has a height extending above the substrate surface between 1 mm to 20 mm, such as between 2 mm to 15 mm, between 4 mm to 12 mm, or between 5 mm to 10 mm. The bottom end of the object (i.e., the end of the object that is inserted into the hole) may extend partially through the substrate, all the way to an opposing second surface of the substrate, or may extend beyond the opposing second surface of the substrate.

In an aspect, the device is a dielectric resonator antenna (DRA). The substrate of the DRA comprises a first substrate surface and an opposing second substrate surface, where the object is a resonator inserted into the hole in the first substrate surface, and then the substrate and object are heated to a sintering temperature. Optionally, the first substrate surface is then metallized. The DRA further comprises a probe antenna inserted in the substrate and having a first end extending above the first (top) substrate surface and a second end extending into the substrate. A portion of the probe antenna is in contact with the metallized surface.

The first substrate surface may be metallized as is known in the art to produce a metal layer having a thickness of at least 0.5 μm, at least 1 μm, at least 2 μm, at least 3 μm, at least 4 μm, at least 5 μm, at least 6 μm, at least 7 μm, at least 8 μm, at least 9 μm, at least 10 μm, at least 11 μm, at least 12 μm, at least 13 μm, at least 14 μm, at least 15 μm, at least 16 μm, at least 17 μm, at least 18 μm, at least 19 μm, at least 20 μm, at least 21 μm, at least 22 μm, at least 23 μm, at least 24 μm, at least 25 μm, at least 26 μm, at least 27 μm, at least 28 μm, at least 29 μm, at least 30 μm, 50 μm or less, 30 μm or less, 29 μm or less, 28 μm or less, 27 μm or less, 26 μm or less, 25 μm or less, 24 μm or less, 23 μm or less, 22 μm or less, 21 μm or less, 20 μm or less, 19 μm or less, 18 μm or less, 17 μm or less, 16 μm or less, 15 μm or less, 14 μm or less, 13 μm or less, 12 μm or less, 11 μm or less, 10 μm or less, 9 μm or less, 8 μm or less, 7 μm or less, 6 μm or less, 5 μm or less, 4 μm or less, 3 μm or less, 2 μm or less, 1 μm or less, or any range formed therefrom. For example, in some aspects, metal layer has a thickness between 1 μm to 25 μm, such as between 5 μm to 20 μm, between 8 μm to 18 μm, or between 10 μm to 15 μm. The thickness of the metal layer may be adjusted depending on the operation frequency of the DRA.

The probe antenna may be any object known in the art suitable for use as part of a DRA, including but not limited to a coaxial cable, microstrip antenna, or a monopole antenna. In an aspect, the metallized surface of the substrate forms a ground plane for the DRA, and only a portion of the probe antenna is in contact with the ground plane. For example, in an aspect where the probe antenna is a coaxial cable, the outer part (jacket) of the cable contacts the metallized surface while the inner part of the cable (the core wire) extends out as the probe.

The second end of the probe antenna may extend partially through the substrate, all the way to the opposing second surface of the substrate, or extend beyond the opposing second surface of the substrate. In an aspect, the DRA further comprises a feed line attached to the second end of the probe antenna. Optionally, the feed line is part of a coaxial cable or microstrip line on the substrate surface.

In an aspect, the resonator of the DRA has a height extending above the first substrate surface of at least 0.5 mm, at least 1 mm, at least 2 mm, at least 3 mm, at least 4 mm, at least 5 mm, at least 6 mm, at least 7 mm, at least 8 mm, at least 9 mm, at least 10 mm, at least 11 mm, at least 12 mm, at least 13 mm, at least 14 mm, at least 15 mm, at least 16 mm, at least 17 mm, at least 18 mm, at least 19 mm, at least 20 mm, at least 21 mm, at least 22 mm, at least 23 mm, at least 24 mm, 25 mm or less, 24 mm or less, 23 mm or less, 22 mm or less, 21 mm or less, 20 mm or less, 19 mm or less, 18 mm or less, 17 mm or less, 16 mm or less, 15 mm or less, 14 mm or less, 13 mm or less, 12 mm or less, 11 mm or less, 10 mm or less, 9 mm or less, 8 mm or less, 7 mm or less, 6 mm or less, 5 mm or less, 4 mm or less, 3 mm or less, 2 mm or less, 1 mm or less, or any range formed therefrom. For example, in some aspects, the object has a height extending above the substrate surface between 1 mm to 20 mm, such as between 2 mm to 15 mm, between 4 mm to 12 mm, or between 5 mm to 10 mm.

In an aspect, the resonator extends below the second surface of the substrate at a distance of at least 0 mm, at least 0.5 mm, at least 1 mm, at least 2 mm, at least 3 mm, at least 4 mm, at least 5 mm, at least 6 mm, at least 7 mm, at least 8 mm, at least 9 mm, at least 10 mm, at least 11 mm, at least 12 mm, at least 13 mm, at least 14 mm, at least 15 mm, at least 16 mm, at least 17 mm, at least 18 mm, at least 19 mm, 20 mm or less, 19 mm or less, 18 mm or less, 17 mm or less, 16 mm or less, 15 mm or less, 14 mm or less, 13 mm or less, 12 mm or less, 11 mm or less, 10 mm or less, 9 mm or less, 8 mm or less, 7 mm or less, 6 mm or less, 5 mm or less, 4 mm or less, 3 mm or less, 2 mm or less, 1 mm or less, 0.5 mm or less, or any range formed therefrom. For example, in some aspects, resonator extends below the second surface of the substrate at a distance between 0 -10 mm, such as 1-10 mm, 2-8 mm, or 4-6 mm. In an aspect, the resonator does not extend beyond the second surface of the substrate. Optionally, the resonator does not contact the second surface of the substrate.

The resonator may have any shape or configuration suitable for use as part of the DRA. Optionally, the resonator optionally has a shape that is a cylinder, annular ring, dome, cone, triangular prism, or a rectangular cuboid.

In an aspect, the DRA comprises two or more holes in the first surface of the substrate and two or more resonators, where each resonator is inserted into a hole in the first substrate surface. Optionally, each of the two or more resonators comprises a ceramic material or a glass-ceramic material that is the same or different from any of the other resonators, and each of the two or more resonators has a height extending above the first substrate surface or a height extending below the second substrate surface that is different from at least one other resonator. The resonators and probe antennas may be arranged in a regular two-dimensional pattern, including but not limited to a rectangular or triangular grid, and/or may arbitrary inter-resonator distances.

In an aspect, the DRA is made from a green material (green tape) comprising one or more organic dispersants and/or binding agents, where the substrate is able to undergo lateral shrinkage of at least 10%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, 30% or less, 29% or less, 28% or less, 27% or less, 26% or less, 25% or less, 24% or less, 23% or less, 22% or less, 21% or less, 20% or less, 19% or less, 18% or less, 17% or less, 16% or less, 15% or less, 14% or less, 13% or less, 12% or less, or any range formed therefrom. For example, in some aspects, the substrate is able to undergo lateral shrinkage of approximately 15% to 25% when heated to a temperature capable of sintering the substrate.

The present disclosure also provides methods of making sintered devices, including DRA devices. The descriptions provided for the devices and components discussed above are intended to apply to these methods as well.

In an aspect, the present disclosure provides a method of making a sintered ceramic device comprising the steps of:
a) generating a hole in a surface of a substrate, wherein the substrate comprises an unsintered ceramic having one or more organic dispersants and/or binding agents;
b) inserting a non-planar object into the hole in the substrate surface and in contact with the substrate, where the object comprises a glass, ceramic, or glass-ceramic material, or precursor thereof, and is stable at temperatures between 850° C. and 3,000° C.; and
c) heating the substrate containing the inserted non-planar object to a temperature between 850° C. and 3,000° C. for a time period from 1 to 60 minutes resulting in covalent bonding of the non-planar object to the substrate. Optionally, the substrate and object are heated at the temperature for a time period between 2 to 60 minutes, between 1 to 30 minutes, between 2 to 30 minutes, between 2 to 20 minutes, between 2 to 15 minutes, or between 3 to 10 minutes.

In some aspects the substrate and object are heated at the temperature for a time period of at least 1 minute, at least 2 minutes, at least 3 minutes, at least 5 minutes, at least 10 minutes, at least 15 minutes, at least 20 minutes, at least 30 minutes, at least 40 minutes, at least 50 minutes, at least 60 minutes, at least 70 minutes, at least 80 minutes, at least 90 minutes, at least 100 minutes, at least 110 minutes, at least 120 minutes, at least 140 minutes, at least 160 minutes, 180 minutes or less, 160 minutes or less, 140 minutes or less, 120 minutes or less, 110 minutes or less, 100 minutes or less, 90 minutes or less, 80 minutes or less, 70 minutes or less, 60 minutes or less, 50 minutes or less, 40 minutes or less, 30 minutes or less, 20 minutes or less, 15 minutes or less, 10 minutes or less, 5 minutes or less, 3 minutes or less, 2 minutes or less, or any range formed therefrom. For example, in some aspects, the substrate and object are heated at the temperature for a time period between 2 to 60 minutes, between 1 to 30 minutes, between 2 to 30 minutes, between 2 to 20 minutes, between 2 to 15 minutes, or between 3 to 10 minutes.

In some aspects, the substrate and inserted non-planar object are heated to a temperature between 900° C. and 2,500° C., between 1,000° C. and 1,900° C., between 1,000 ° C. and 2,000° C., or between 1,500° C. and 1,900° C. In an aspect, the substrate and inserted non-planar object are heated to a temperature of at least 1,000° C. for 1 to 60 minutes, such as to a temperature of at least 1,000° C. for 3 to 10 minutes.

In some aspects, the substrate has a thickness of 200 μm or less, 150 μm or less, 100 μm or less, 40 μm or less, or between 10 μm and 20 μm. In an aspect, the substrate undergoes lateral shrinkage of approximately 15% to 25%, approximately 16% to 20%, or approximately 18% to 22%, during the heating step.

In an aspect, prior to step c), the substrate containing the inserted non-planar object is heated to an intermediate temperature of at least 20° C., at least 25° C., at least 30° C., at least 40° C., at least 50° C., at least 60° C., at least 80° C., at least 100° C., at least 150° C., at least 200° C., at least 250° C., at least 300° C., at least 350° C., at least 400° C., at least 450° C., at least 500° C., 600° C. or less, 500° C. or less, 450° C. or less, 400° C. or less, 350° C. or less, 300° C. or less, 250° C. or less, 200° C. or less, 150° C. or less, 100° C. or less, 80° C. or less, 60° C. or less, 50° C. or less, 40° C. or less, 30° C. or less, 25° C. or less, or any range formed therefrom. For example, in some aspects, the substrate containing the inserted non-planar object is heated to an intermediate temperature between 25° C. and 500° C. for a time period sufficient to remove at least 50% by weight of the organic dispersants and/or binding agents, such as for a time period sufficient to remove at least 65%, at least 75%, at least 80%, at least 85%, at least 90%, at least 95%, or 100% of the organic dispersants and/or binding agents, by weight. In an aspect, the substrate containing the inserted non-planar object is heated to an intermediate temperature between 40° C. and 400° C., between 50° C. and 300° C., or between 80° C. and 150° C.

In an aspect, the method further comprises generating the hole in the substrate surface by mechanical drilling the substrate surface, puncturing the substrate surface, etching or ablating the hole in the substrate surface using a laser, or any combination thereof. One or more slits or cutouts radially extending from a center of the hole may further be drilled or etched in the substrate to reduce or prevent cracking.

### Aspects of the Disclosure

The disclosure is further summarized in the following paragraphs and is further characterized by combinations of any and all of the various aspects described therein.

According to aspect (1), a device is provided comprising a ceramic substrate comprising a hole in a surface of the substrate, wherein the substrate has a thickness of 200 μm or less; and a non-planar object inserted into the hole in the surface and in contact with the substrate, wherein the object comprises a glass, ceramic, glass-ceramic material, or precursor thereof.

According to aspect (2), the device of aspect (1) is provided, wherein the device is a dielectric resonator antenna and the object is a resonator inserted into the hole in the substrate surface, wherein the device further comprises a probe antenna inserted in the substrate and having a first end extending above a first substrate surface and a second end extending into the substrate.

According to aspect (3), the device of aspect (1) or (2) is provided, wherein the substrate has a thickness of 100 μm or less.

According to aspect (4), the device of any of aspects (1) to (3) is provided, wherein the substrate has a thickness of 40 μm or less.

According to aspect (5), the device of any of aspects (1) to (4) is provided, wherein the substrate comprises an unsintered ceramic precursor comprising one or more organic dispersants and/or binding agents.

According to aspect (6), the device of aspect (5) is provided, wherein the substrate undergoes lateral shrinkage of approximately 15% to 25% when heated to a sintering temperature.

According to aspect (7), the device of any of aspects (1) to (4) is provided, wherein the substrate comprises a sintered ceramic that is covalently bonded with the object inserted into the hole.

According to aspect (8), the device of any of aspects (1) to (7) is provided, wherein the substrate is a ribbon ceramic.

According to aspect (9), the device of any of aspects (1) to (8) is provided, wherein the object comprises a ceramic material that is the same or different than the substrate.

According to aspect (10), the device of any of aspects (1) to (9) is provided, wherein the object is stable at temperatures between 850° C. and 3,000° C.

According to aspect (11), the device of any of aspects (1) to (10) is provided, wherein the object is stable at temperatures between 1,000° C. and 2,000° C.

According to aspect (12), the device of any of aspects (1) to (11) is provided, wherein the object is stable at a sintering temperature used to form the substrate.

According to aspect (13), the device of any of aspects (1) to (12) is provided, wherein the object has a height extending above the substrate surface of between 1 mm to 20 mm.

According to aspect (14), the device of any of aspects (1) to (13) is provided, wherein the hole is circular and has a diameter between 1 mm and 15 mm.

According to aspect (15), the device of any of aspects (1) to (14) is provided, wherein the hole has one or more slits or cutouts radially extending from a center of the hole.

According to aspect (16), the device of any of aspects (1) to (15) is provided, wherein the hole extends through the substrate from a first substrate surface to an opposing second substrate surface.

According to aspect (17), the device of any of aspects (1) to (16) is provided, wherein the substrate comprises aluminum oxide (Al₂O₃), aluminium oxynitride ((AlN)ₓ—(Al₂O₃)₁₋ₓ), silicon carbide (SiC), silicon nitride (Si₃N₄), titanium carbide (TiC), titanium nitride (TiN), titanium oxide (TiO₂), yttrium oxide (Y₂O₃), stabilized zirconium dioxide (ZrO₂), zirconium carbide (ZrC), magnesium oxide (MgO), or any combination thereof.

According to aspect (18), a dielectric resonator antenna is provided comprising: a) a ceramic substrate having a first substrate surface and an opposing second substrate surface, wherein the substrate comprises a hole in the first substrate surface, the first substrate surface is metallized, and the substrate has a thickness of 200 μm or less; b) a resonator inserted into the hole in the first substrate surface and in contact with the substrate, wherein the resonator comprises a glass, ceramic, glass-ceramic material, or precursor thereof; and c) a probe antenna inserted in the substrate and having a first end extending above the first substrate surface and a second end extending into the substrate, wherein a portion of the probe antenna is in contact with the metallized surface.

According to aspect (19), the dielectric resonator antenna of aspect (18), or any preceding aspect, is provided, wherein the substrate comprises aluminum oxide (Al₂O₃), aluminium oxynitride ((AlN)ₓ—(Al₂O₃)₁₋ₓ), silicon carbide (SiC), silicon nitride (Si₃N₄), titanium carbide (TiC), titanium nitride (TiN), titanium oxide (TiO₂), yttrium oxide (Y₂O₃), stabilized zirconium dioxide (ZrO₂), zirconium carbide (ZrC), magnesium oxide (MgO), or any combination thereof.

According to aspect (20), the dielectric resonator antenna of aspect (18) or (19), or any preceding aspect, is provided, wherein the substrate has a thickness of 100 μm or less.

According to aspect (21), the dielectric resonator antenna of any of aspects (18) to (20), or any preceding aspect, is provided, wherein the substrate comprises a sintered ceramic that is covalently bonded with the resonator inserted into the hole in the first substrate surface.

According to aspect (22), the dielectric resonator antenna of any of aspects (18) to (21), or any preceding aspect, is provided, wherein the resonator comprises a ceramic material that is the same or different than the substrate.

According to aspect (23), the dielectric resonator antenna of any of aspects (18) to (22), or any preceding aspect, is provided, wherein the resonator is stable at temperatures between 1000° C. and 2,000° C.

According to aspect (24), the dielectric resonator antenna of any of aspects (18) to (23), or any preceding aspect, is provided, wherein the resonator has a height extending above the first substrate surface between 1 mm to 20 mm, and a height extending below the second substrate surface between 0 μm to 10 mm.

According to aspect (25), the dielectric resonator antenna of any of aspects (18) to (24), or any preceding aspect, is provided, wherein the resonator has a shape that is a cylinder, annular ring, dome, cone, triangular prism, or a rectangular cuboid.

According to aspect (26), the dielectric resonator antenna of any of aspects (18) to (25), or any preceding aspect, is provided, further comprising a feed line attached to the second end of the probe antenna.

According to aspect (27), the dielectric resonator antenna of aspect (26), or any preceding aspect, is provided, wherein the feed line is a coaxial cable or wire or a microstrip line on the substrate surface.

According to aspect (28), the dielectric resonator antenna of any of aspects (18) to (27), or any preceding aspect, is provided, wherein the hole has one or more slits or cutouts radially extending from a center of the hole.

According to aspect (29), the dielectric resonator antenna of any of aspects (18) to (28), or any preceding aspect, is provided, further comprising two or more holes in the first surface of the substrate and two or more resonators, wherein each resonator is inserted into a separate hole in the first substrate surface.

According to aspect (30), the dielectric resonator antenna of aspect (29), or any preceding aspect, is provided, wherein each of the two or more resonators comprises a ceramic material or a glass-ceramic material that is the same or different from any of the other resonators, and wherein each of the two or more resonators has a height extending above the first substrate surface or a height extending below the second substrate surface that is different from at least one other resonator.

According to aspect (31), a method of making a sintered ceramic device is provided comprising the steps of: a) generating a hole in a surface of a substrate, wherein the substrate has a thickness of 200 μm or less and comprises an unsintered ceramic having one or more organic dispersants and/or binding agents; b) inserting a non-planar object into the hole in the substrate surface and in contact with the substrate, wherein the object comprises a glass, ceramic, or glass-ceramic material, or precursor thereof, and is stable at temperatures between 850° C. and 3,000° C.; c) heating the substrate containing the inserted non-planar object to an intermediate temperature between 25° C. and 500° C., thereby removing the organic dispersants and/or binding agents; and d) heating the substrate containing the inserted non-planar object to a temperature between 850° C. and 3,000° C. for a time period from 1 to 60 minutes resulting in covalent bonding of the non-planar object to the substrate.

According to aspect (32), the method of aspect (31), or any preceding aspect, is provided, wherein the substrate comprises aluminum oxide (Al₂O₃), aluminium oxynitride ((AlN)ₓ—(Al₂O₃)₁₋ₓ), silicon carbide (SiC), silicon nitride (Si₃N₄), titanium carbide (TiC), titanium nitride (TiN), titanium oxide (TiO₂), yttrium oxide (Y₂O₃), stabilized zirconium dioxide (ZrO₂), zirconium carbide (ZrC), magnesium oxide (MgO), or any combination thereof.

According to aspect (33), the method of aspect (31) or (32), or any preceding aspect, is provided wherein the substrate has a thickness of 100 μm or less.

According to aspect (34), the method of any of aspects (31) to (33), or any preceding aspect, is provided, wherein the substrate undergoes lateral shrinkage of approximately 15% to 25% during the heating step.

According to aspect (35), the method of any of aspects (31) to (34), or any preceding aspect, is provided, wherein the substrate and inserted non-planar object are heated to a temperature of at least 1,000° C. for 1 to 60 minutes.

According to aspect (36), the method of any of aspects (31) to (35), or any preceding aspect, is provided, wherein the substrate and inserted non-planar object are heated to a temperature of at least 1,000° C. for 3 to 10 minutes.

According to aspect (37), the method of any of aspects (31) to (36), or any preceding aspect, is provided, wherein the substrate and inserted non-planar object are heated to a temperature between 1,000° C. and 1,900° C.

According to aspect (38), the method of any of aspects (31) to (37), or any preceding aspect, is provided, wherein the object comprises a ceramic material that is the same or different than the substrate.

According to aspect (39), the method of any of aspects (31) to (38), or any preceding aspect, is provided, wherein generating the hole in the substrate surface comprises mechanical drilling, puncturing, etching the hole using a laser, or combinations thereof.

According to aspect (40), the method of any of aspects (31) to (39), or any preceding aspect, is provided, further comprising drilling or etching one or more slits or cutouts radially extending from a center of the hole along the substrate.

According to aspect (41), a device, dielectric resonator antenna, or method is provided that is a combination of any one or more of aspects (1) through (40) or any portion(s) thereof.

### Example 1—Sintered Ribbon Ceramic With Three-Dimensional Structures

In one example of the present disclosure, an object, such as a ceramic pin, is embedded in a thin ceramic substrate, such as a ribbon ceramic. The intermediate product of the object loosely embedded in an unsintered ceramic precursor (i.e., green tape) is also intended to be encompassed by this example. This type of design is particularly useful for generating improved DRAs and arrays.

The present disclosure also provides a process for making such devices by fabricating holes (e.g., by laser etching or ablation) in an unsintered ceramic precursor (including, but not limited to, 3 mol % yttria-stabilized zirconia “3YSZ”), placing a three-dimensional object (e.g., a zirconia pin) into the hole, and then firing the ceramic precursor with the object using a continuous sintering process or through batch firing. The sintering process results in a constriction of the hole around the object, locking the object in place.

This process is advantageous in that it provides a larger tolerance for the dimensions of the object and the dimensions of the hole that will result in an object being securely attached to the ceramic substrate. As a result, this process is more compatible with high-volume manufacturing. Additionally, the ablation process to form the hole in the unsintered ceramic precursor (i.e., green tape) is able to be performed faster than forming the hole in a sintered ceramic, which allows for higher output.

Using laser etching or laser ablation to form the hole is also advantageous over mechanical methods (i.e., mechanically drilling or puncturing the substrate) in that laser etching and ablation avoids or reduces mechanical damage which warps the substrate and causes cracks to appear post-sintering.

With regard to DRAs, this fabrication process provides more reliable bonding between the resonators and the ceramic substrate than glue-based methods, especially for applications where flexibility of the substrate (i.e., conformal antennas and arrays) is required. This approach also provides greater control over the resonator height above the substrate plane, which determines the radiative properties of the DRA. Hence, identical building blocks (cylinders, prisms, etc.) can be used in a simplified manufacturing process while achieving complex resonator shapes (see FIG. 1, panels c and d).

In printed circuit board applications, it is often desirable to have the holes (and therefore the inserted objects) in the substrate surface to be very close together. However, it is difficult to reliably make the holes be close together with high precision. In the present methods, where a laser is used to generate the holes in an unsintered ceramic substrate, the holes are able to be generated very close to each other with high precision, which will then become even closer after the sintering process. Additionally, being able to generate the holes in close proximity will allow the objects to be easily connected if desired.

One alternative approach to fabricating ribbon ceramic devices with three-dimensional structures is to create a hole in the ceramic material post-sintering. However, snuggly fitting the ceramic pin into the hole could be challenging. The hole dimensional accuracy and precision generally is important. Additionally, there may be variability in the pin diameter, and each hole would then need to be made for that specific pin. Creating the hole after sintering could result in a relatively weakened interior wall of the hole, which could result in a failure of the part. Accordingly, joining the pin with the substrate by sintering is advantageous in eliminating any mechanical motions during and post processing. As a result, such methods can be widely applied to the mass fabrication of three-dimensional ceramic objects with consistent quality.

### Example 2—Fabricated Single-Resonator and Compound-Resonator DRAs

FIG. 1 schematically shows a single-resonator DRA (panels a and b) and a compound-resonator DRA (panels c and d). The dielectric resonator antenna (1) comprises a substrate (4) and one or more resonator structures (2). As described in the present disclosure, and illustrated in panels b, c and d, the substrate (4) has at least one hole (not seen) through the surface, where the one or more resonators (2) are inserted through the holes and may extend beyond the bottom surface (12) of the substrate (4). The top surface (11) of the substrate (4) contains a metallized layer (10), which forms a ground plane on the top surface (11). A probe antenna (3) is inserted into the substrate (4) and contacts the metallized layer (10).

The resonator material can be the same as or different from the material of the substrate as long as the sintering process is not affected. In some aspects, both the resonator material and the material of the substrate are the same green (unsintered) ceramic, which allows the resonator and substrate to shrink to the same extent during sintering. FIG. 1, panel a, illustrates a conventional attachment method using a glue to attach the resonator (2) to the substrate (4). However, reliability of such a structure may be poor because of the small contact area between the resonator (2) and the substrate (4).

FIG. 1, panel b, proposes an alternative attachment method where a longer resonator (2) is inserted through a pre-drilled hole in the substrate and extends beyond the bottom surface (12) of the substrate (4). In both cases, the height of the resonator (2) above the top substrate surface (11) is the same. Electromagnetic simulations and measurements of the S11 parameter of the antenna prototype based on a conventional printed circuit board demonstrated the validity of this approach.

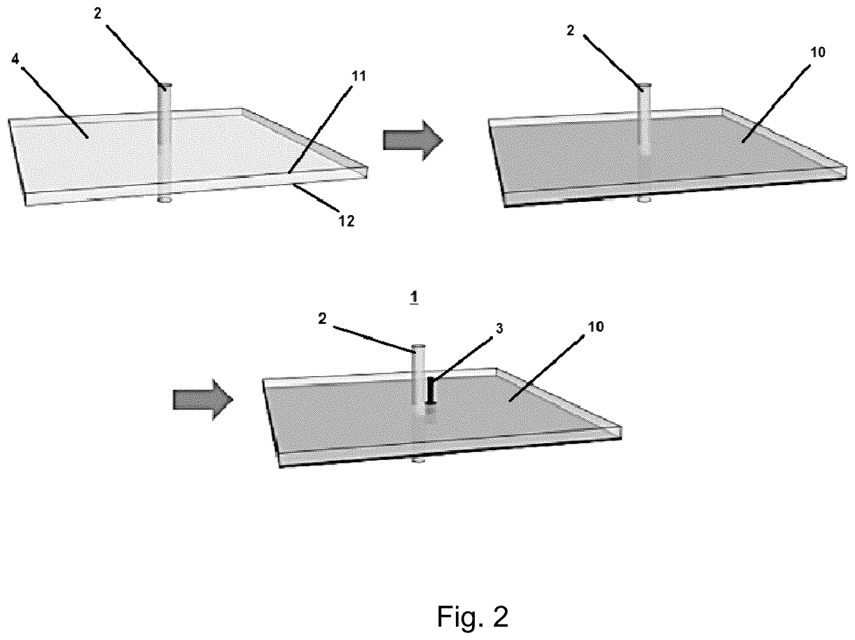

In the fabrication process, the resonator (2) to be attached to the ground plane is fabricated first, followed by metallization of the top surface (11) of the substrate (i.e., the ground plane). The hole for the probe antenna (3) is drilled into the substrate (4) and the probe antenna (3) is soldered or otherwise coupled to the metallized layer (10) forming the ground plane (FIG. 2).

### Example 3—Green Tape Processing

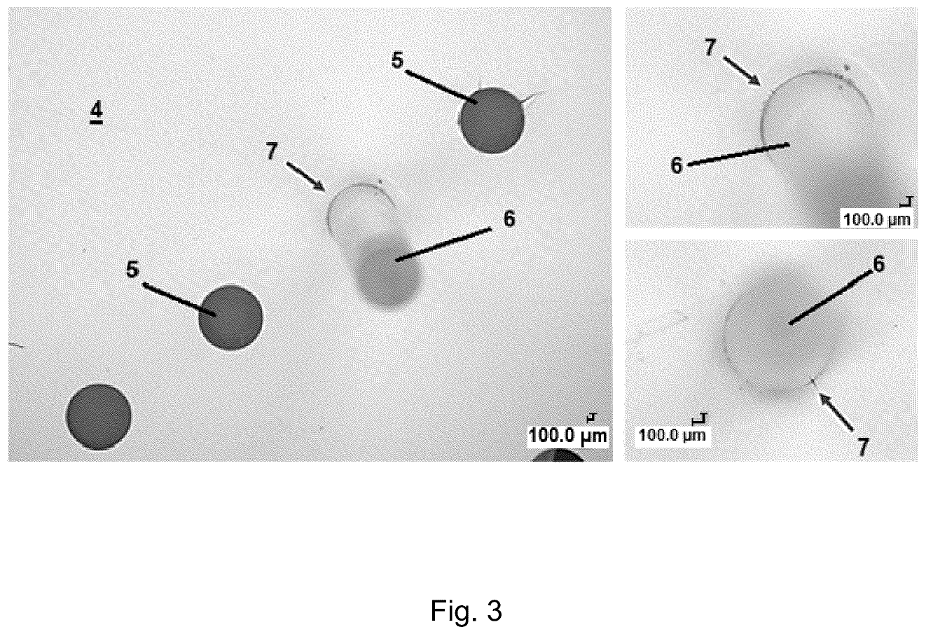

Multiple holes (5) were fabricated in a 40 μm thick substrate (4) comprising 3YSZ green tape using laser ablation with a 532 nm picosecond laser source. Holes (5) of 1.21 mm diameter were used for a 1.27 mm diameter zirconia pin (6). The pin (6) was gently inserted into the hole (5) with a slight rotational motion. The pin (6) sat vertically in the hole (5) but could fall out if pushed. Microscope images of the pin (6) inserted into the green tape substrate (4) are shown in FIG. 3 (scale bars are 100.0 μm).

### Example 4—Firing Process

For a continuous sintering approach, 3YSZ green tape is fired at a rate of 16 inches per minute (ipm) and held at a peak temperature of 1566° C. for 3 minutes to complete restructuring.

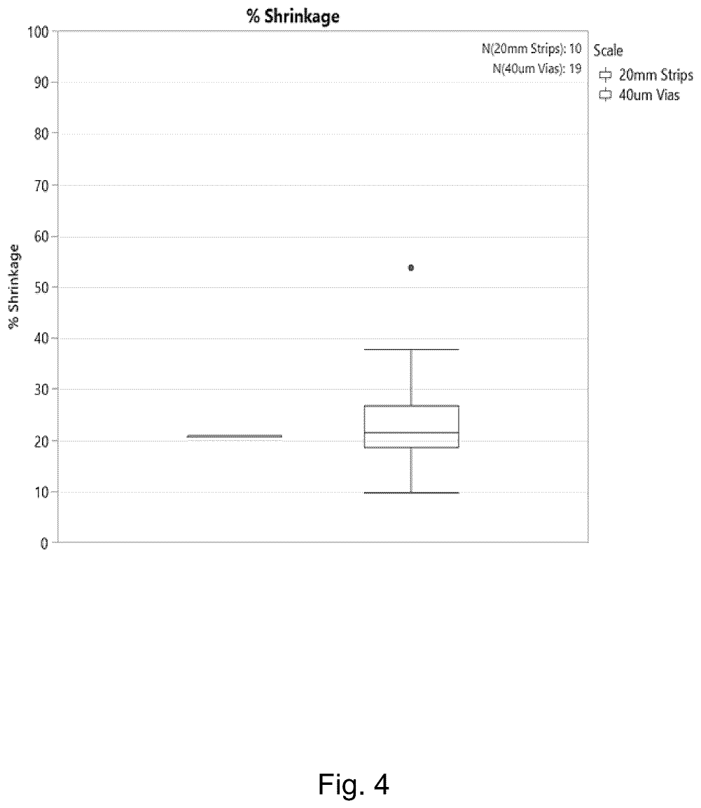

The 3YSZ green tape undergoes an isotropic shrinkage of ˜21%. FIG. 4 shows a box plot of percentage shrinkage of laser damaged region in 3YSZ green tape upon firing. Data was taken from measuring 20 mm wide strips of 3YSZ green tape pre-and post-firing with 20× magnification and field of view (FOV) ˜25 mm×25 mm (presented on the left hand side in the graph of FIG. 4). Data was also taken from measuring ˜40 μm diameter holes, pre-and post-firing at 50× magnification and FOV ˜500 μm×500 μm (presented on the right hand side in the graph of FIG. 4). The error in measurement is likely larger for the vias due to the scale difference as well as it was difficult to get good focus on all parts for the hole measurements. At a target of 1.21 mm diameter, a shrinkage to 0.956 mm diameter may be expected. Oversizing the intended insertion hole to 1.53 mm should result in target 1.21 mm diameter.

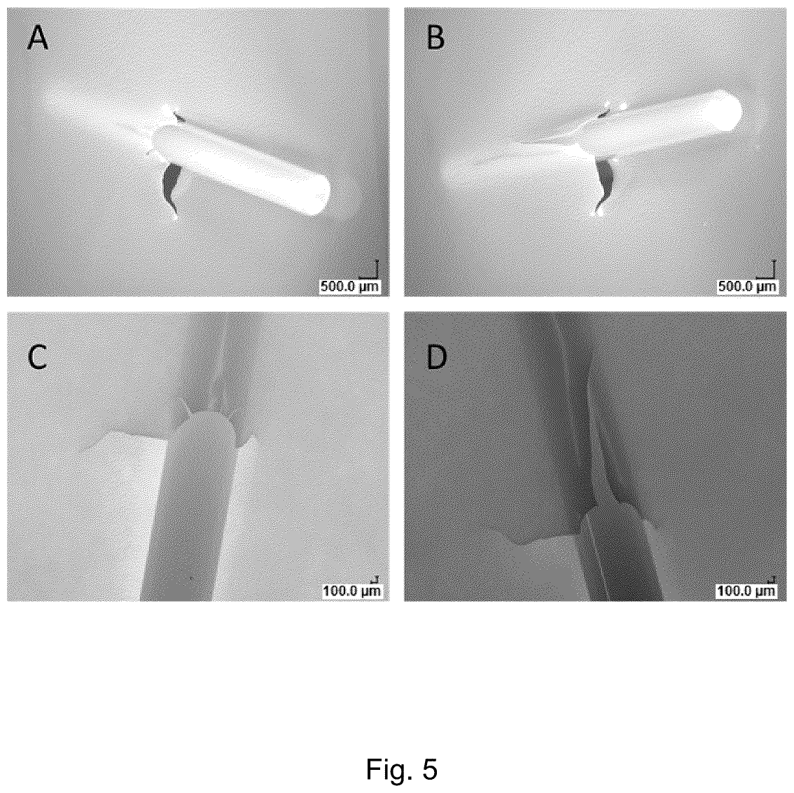

FIG. 5 is a series of microscope images of the DRA sample after sintering (scale bars are 500.0 μm for panels A and B, and 100.0 μm for panels C and D). When the part was put in the furnace, the ceramic pin was accidentally bumped and tipped over, so the pin was not vertical during conveyance through firing. After sintering, the pin was rigidly locked into the ribbon ceramic and was not able to be removed by hand. Partially due to the tilt of the pin before firing, cracks developed around the pin, but the cracks did not propagate when force was applied to attempt to remove the pin. If more careful steps are taken to avoid accidental bumping/tipping, it is anticipated that the pin can be maintained in an upright state without any cracking or ripping of the tape (see, e.g., Example 5).

The green tape with the three-dimensional structures could also be fired with traditional batch firing. The static nature of batch firing would minimize the chances of the pin falling over, as in the continuous conveyance with tension.

In an aspect, the ablated hole diameter (after the sintering process) is the same or slightly smaller than the pin diameter for a snug fit in the green tape. If the hole is too large, the pin will fall through. If the hole is too small, the green tape is crushed and damaged during insertion.

### Example 5—Controlling Object Orientation and Insertion Depth

Additional methods can also be utilized to ensure that the inserted object (i.e., the ceramic pin) stays vertical during the firing process. These approaches can also be used to control the depth within the substrate that the object is inserted to.

In one aspect, a sacrificial film is used on top of or below the ribbon ceramic, mimicking a thicker substrate. The hole is generated to partially or fully penetrate the film and add rigidity to the inserted object position. The sacrificial film is then removed during or after the firing process. Alternatively, a thicker ceramic piece is used as a fixture for inserting the objects into the substrate, with precisely controlled well depths.

In another aspect, robotics are used to gently insert the object and transport the material with greater precision, where the insertion of the object into the substrate is performed in-line with the firing process. A green tape leader is continuously fed into a furnace. Laser ablation is performed on the green tape before that portion of the green tape enters the furnace, and the object is gently inserted into the green tape using a robotic system also before that portion of the green tape enters the furnace. This will result in the objects being inserted into the substrate at a more reproducible depth.

### Example 6—Mitigating the Formation of Cracks

To improve the quality and performance of the devices, steps can be taken to prevent or reduce the formation of cracks arising from the formation of the holes in the substrate and the insertion of the three-dimensional objects (i.e., ceramic pins) into the holes.

In one aspect, the holes in the green tape are created having a slightly larger diameter compared to the size of the object to be inserted. Assuming the linear shrinkage of the tape is ˜20% upon sintering, the percent of diameter oversize can be ˜15-18% with respect to the diameter of the object (for example, approximately 1.42 mm to 1.48 mm). During sintering, the hole will shrink until it contacts the outer surface of the object. This approach minimizes the stress induced by sintering shrinkage that is responsible for the cracking.

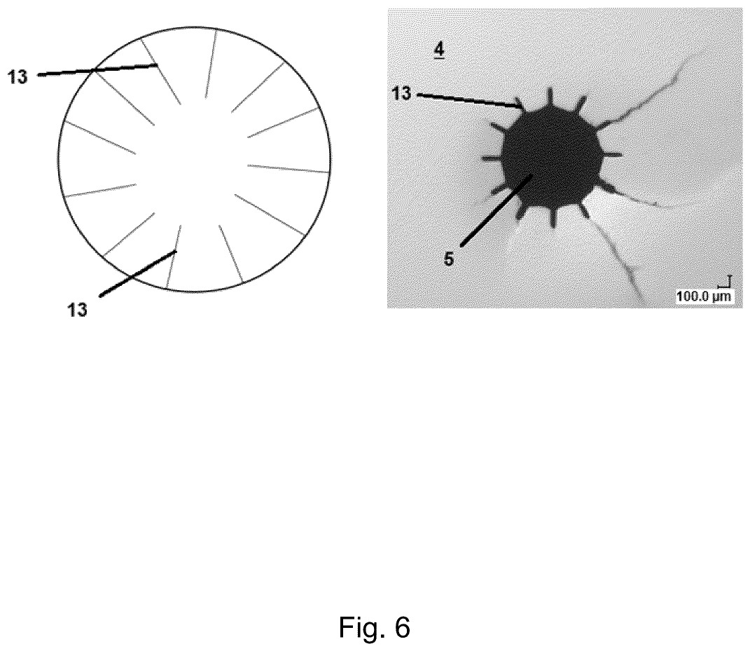

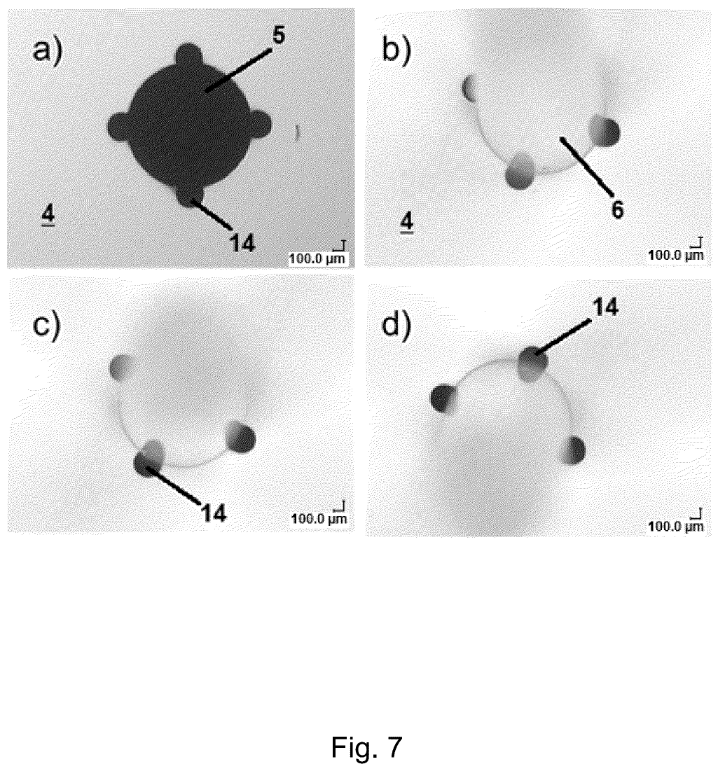

As illustrated in FIGS. 6 and 7, an additional method to prevent or reduce the formation of cracks in a green tape substrate (4) involves forming the holes (5) in the green tape substrate (8) with a plurality of slits (13) or cutouts (14) extending from the hole (5) so that when the ceramic pin (6) is pushed into the hole, there is less mechanical stress concentrated around the contacting surface (see FIGS. 6 and 7, scale bars are 100.0 μm).

Having now fully described the present invention in some detail by way of illustration and examples for purposes of clarity of understanding, it will be obvious to one of ordinary skill in the art that the same can be performed by modifying or changing aspects of the disclosure within a wide and equivalent range of conditions, formulations and other parameters without affecting the scope of the invention or any specific aspect thereof, and that such modifications or changes are intended to be encompassed within the scope of the appended claims.

When a group of materials, compositions, components or compounds is disclosed herein, it is understood that all individual members of those groups and all subgroups thereof are disclosed separately. Every formulation or combination of components described or exemplified herein can be used to practice the invention, unless otherwise stated. Whenever a range is given in the specification, for example, a temperature range, a time range, or a composition range, all intermediate ranges and subranges, as well as all individual values included in the ranges given are intended to be included in the disclosure. Additionally, the end points in a given range are to be included within the range. In the disclosure and the claims, “and/or” means additionally or alternatively. Moreover, any use of a term in the singular also encompasses plural forms.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements.

Directional terms as used herein, such as up, down, right, left, front, back, top, bottom, are made only with reference to the figures as drawn and are not intended to imply absolute orientation.

One of ordinary skill in the art will appreciate that starting materials, device elements, analytical methods, mixtures and combinations of components other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. The invention illustratively described herein suitably may be practiced in the absence of any element or elements, limitation or limitations which is not specifically disclosed herein. Headings are used herein for convenience only.

All publications referred to herein are incorporated herein to the extent not inconsistent herewith. Some references provided herein are incorporated by reference to provide details of additional uses of the invention. All patents and publications mentioned in the specification are indicative of the levels of skill of those skilled in the art to which the invention pertains. References cited herein are incorporated by reference herein in their entirety to indicate the state of the art as of their filing date and it is intended that this information can be employed herein, if needed, to exclude specific aspects that are in the prior art.

What is claimed is:

1. A device comprising:
a ceramic substrate comprising a hole in a surface of the substrate, wherein the substrate has a thickness of 200 μm or less; and
a non-planar object inserted into the hole in the surface and in contact with the substrate, wherein the object comprises a glass, ceramic, glass-ceramic material, or precursor thereof.

2. The device of claim 1, wherein the device is a dielectric resonator antenna and the object is a resonator inserted into the hole in the substrate surface, wherein the device further comprises a probe antenna inserted in the substrate and having a first end extending above a first substrate surface and a second end extending into the substrate.

3. The device of claim 1, wherein the substrate comprises a sintered ceramic that is covalently bonded with the object inserted into the hole.

4. The device of claim 1, wherein the substrate has a thickness of 100 μm or less.

5. The device of claim 1, wherein the substrate comprises an unsintered ceramic precursor comprising one or more organic dispersants and/or binding agents.

6. The device of claim 5, wherein the substrate undergoes lateral shrinkage of approximately 15% to 25% when heated to a sintering temperature.

7. The device of claim 1, wherein the substrate is a ribbon ceramic.

8. The device of claim 1, wherein the object is stable at temperatures between 850° C. and 3,000° C.

9. The device of claim 1, wherein the object is stable at a sintering temperature used to form the substrate.

10. The device of claim 1, wherein the object has a height extending above the substrate surface of between 1 mm to 20 mm.

11. The device of claim 1, wherein the hole is circular and has a diameter between 1 mm and 15 mm.

12. The device of claim 1, wherein the hole has one or more slits or cutouts radially extending from a center of the hole.

13. The device of claim 1, wherein the hole extends through the substrate from a first substrate surface to an opposing second substrate surface.

14. The device of claim 1, wherein the substrate comprises aluminum oxide (Al₂O₃), aluminium oxynitride ((AlN)ₓ—(Al₂O₃)₁₋ₓ), silicon carbide (SiC), silicon nitride (Si₃N₄), titanium carbide (TiC), titanium nitride (TiN), titanium oxide (TiO₂), yttrium oxide (Y₂O₃), stabilized zirconium dioxide (ZrO₂), zirconium carbide (ZrC), magnesium oxide (MgO), or any combination thereof.

15. A method of making a sintered ceramic device comprising the steps of:
generating a hole in a surface of a substrate, wherein the substrate has a thickness of 200 μm or less and comprises an unsintered ceramic having one or more organic dispersants and/or binding agents;
inserting a non-planar object into the hole in the substrate surface and in contact with the substrate, wherein the object comprises a glass, ceramic, or glass-ceramic material, or precursor thereof, and is stable at temperatures between 850° C. and 3,000° C.;
heating the substrate containing the inserted non-planar object to an intermediate temperature between 25° C. and 500° C., thereby removing the organic dispersants and/or binding agents; and
heating the substrate containing the inserted non-planar object to a temperature between 850° C. and 3,000° C. for a time period from 1 to 60 minutes resulting in covalent bonding of the non-planar object to the substrate.

16. The method of claim 15, wherein the substrate comprises aluminum oxide (Al₂O₃), aluminium oxynitride ((AlN)ₓ—(Al₂O₃)₁₋ₓ), silicon carbide (SiC), silicon nitride (Si₃N₄), titanium carbide (TiC), titanium nitride (TiN), titanium oxide (TiO₂), yttrium oxide (Y₂O₃), stabilized zirconium dioxide (ZrO₂), zirconium carbide (ZrC), magnesium oxide (MgO), or any combination thereof.

17. The method of claim 15, wherein the substrate has a thickness of 100 μm or less.

18. The method of claim 15, wherein the substrate and inserted non-planar object are heated to a temperature of at least 1,000° C. for 1 to 60 minutes.

19. The method of claim 15, wherein the substrate and inserted non-planar object are heated to a temperature between 1,000° C. and 1,900° C.

20. The method of claim 15, comprising drilling or etching one or more slits or cutouts radially extending from a center of the hole along the substrate.
